(19) United States
(12) Patent Application Publication
(10) Pub. No.: US 2013/0162550 A1
(43) Pub. Date: Jun. 27, 2013

(54) Touch Panel Device and Scanning Method Therein

(71) Applicants: Chun-Hsi Chen, Pingtung City (TW); Jun-Shih Chung, Taichung City (TW); Chien-Hsiang Huang, Tainan City (TW)

(72) Inventors: Chun-Hsi Chen, Pingtung City (TW); Jun-Shih Chung, Taichung City (TW); Chien-Hsiang Huang, Tainan City (TW)

(73) Assignee: HANNSTAR DISPLAY CORPORATION, New Taipei City (TW)

(21) Appl. No.: 13/470,839

(22) Filed: May 14, 2012

(30) Foreign Application Priority Data
Dec. 23, 2011 (CN) 201110446854.9

(51) Int. Cl. G06F 3/041

(52) U.S. Cl. 345/173

(57) ABSTRACT

A touch panel device and a scanning method in the touch panel device are provided. The touch panel device includes first sensing lines, second sensing lines and a controlling module. The first sensing lines and the second sensing lines are alternately arranged and are in parallel with each other along a first direction. The controlling module is configured to scan the first sensing lines and the second sensing lines during a plurality of first frame periods and a plurality of second frame periods, respectively, which are alternately arranged according to a predetermined frame rate.

### RELATED APPLICATIONS

This application claims priority to Chinese Application Serial Number 201110446854.9, filed Dec. 23, 2011, which is herein incorporated by reference.

### BACKGROUND

1. Technical Field

The present disclosure relates to a touch panel mechanism, and more particularly, to a touch panel device and a scanning method therein.

2. Description of Related Art

A touch panel is equipped with an input function without a mouse or a keyboard. In various types of touch sensing devices, commands may be directly inputted on a display screen of the touch panel, usually by a finger or a stylus pen, such that the touch panel can be operated simply. Such an operating manner is intuitive without complicated considerations, and is very convenient to be applied in a graphical user interface (GUI). So far, the touch panel has been widely applied in various fields such as a smart phone, a personal digital assistant, a tablet personal computer, a terminal device of a bank or a government institution, a medical instrument and a navigation display device.

In general, the touch panel with a power saving function may be operated in two modes, i.e., an idle mode and an operating mode. The idle mode is selected for saving power consumption. When a finger or an object does not touch the display screen, the touch panel is operated in the idle mode. At that moment, a scanning of the touch panel is operated at a lower frequency. The times of charging and discharging sensing electrodes are decreased to reduce the power consumption. When the finger touches the display screen, the touch panel is switched from the idle mode to the operating mode. At that moment, the scanning of the touch panel is operated at a higher frequency in order to detect precisely the finger's touch position. When the finger leaves the display panel, the touch panel returns from the operating mode to the idle mode.

As known in the prior art, a predetermined frame rate in the idle mode is decreased in order to achieve the object of saving power. However, since the predetermined frame rate is decreased, this method results in a longer reaction time period as the finger touches the display screen, causing operation inconvenience.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

An object of the present disclosure is related to a scanning mechanism of a touch panel to solve a problem of an inconvenient operation caused by decreasing a predetermined frame rate.

An aspect of the present invention is to provide a touch panel device. The touch panel device includes first sensing lines, second sensing lines and a controlling module. The first sensing lines and the second sensing lines are alternately arranged and are in parallel with each other along a first direction. The controlling module is configured to scan the first sensing lines and the second sensing lines during first frame periods and second frame periods, respectively, which are alternately generated according to the predetermined frame rate, wherein the controlling module is equipped with an idle mode and an operating mode, and when the controlling module is in the idle mode, the controlling module only scans the first sensing lines during each of the first frame periods to acquire a first group of sensing data values, and the controlling module only scans the second sensing lines during each of the second frame periods to acquire a second group of sensing data values, and the controlling module determines whether a touch event occurs according to the first group of sensing data values and the second group of sensing data values.

In one embodiment of the present invention, when the controlling module is in the operating mode, the controlling module scans the first sensing lines and the second sensing lines during each of the first frame periods and each of the second frame periods.

In another embodiment of the present invention, the touch panel device further includes third sensing lines and fourth sensing lines, wherein the third sensing lines and the fourth sensing lines are alternately arranged and are in parallel with each other along a second direction which is perpendicular to the first direction. When the controlling module is in the idle mode, the controlling module only scans the third sensing lines during each of the first frame periods to acquire a third group of sensing data values, and the controlling module only scans the fourth sensing lines during each of the second frame periods to acquire a fourth group of sensing data values, and the controlling module determines whether the touch event occurs according to the first group of sensing data values, the second group of sensing data values, the third group of sensing data values and the fourth group of sensing data values.

In yet another embodiment of the present invention, when the touch event occurs, the controlling module is switched to be in the operating mode and combines the first group of sensing data values, the second group of sensing data values, the third group of sensing data values and the fourth group of sensing data values, which are acquired last in the idle mode, into a group of initial data values in the operating mode.

In one embodiment of the present invention, when the controlling module is in the operating mode, the controlling module scans the first sensing lines, the second sensing lines, the third sensing lines and the fourth sensing lines during each of the first frame periods and each of the second frame periods.

Another aspect of the present invention is to provide a scanning method of the touch panel device. The scanning method includes the steps described below. A touch panel device is provided, in which the touch panel device is equipped with an idle mode and an operating mode, and has first sensing lines and second sensing lines which are alternately arranged and are in parallel with each other along a first direction. First frame periods and second frame periods are generated alternately according to a predetermined frame rate. When the touch panel device is in the idle mode, the touch panel device only scans the first sensing lines during each of the first frame periods to acquire a first group of sensing data values, and only scans the second sensing lines during each of the second frame periods to acquire a second group of sensing data values, and determines whether a touch event occurs according to the first group of sensing data values and the second group of sensing data values.

In one embodiment of the present invention, the scanning method further includes the steps described below. When the touch panel device is in the operating mode, the touch panel device scans the first sensing lines and the second sensing lines during each of the first frame periods and each of the second frame periods.

In another embodiment of the present invention, the touch panel device has third sensing lines and fourth sensing lines which are alternately arranged and are in parallel with each other along a second direction which is perpendicular to the first direction. The scanning method of the touch panel device further includes the steps described below. When the touch panel device is in the idle mode, the touch panel device only scans the third sensing lines during each of the first frame periods to acquire a third group of sensing data values, and only scans the fourth sensing lines during each of the second frame periods to acquire a fourth group of sensing data values, and determines whether the touch event occurs according to the first group of sensing data values, the second group of sensing data values, the third group of sensing data values and the fourth group of sensing data values.

In yet another embodiment of the present invention, when the touch event occurs, the touch panel device is switched to be in the operating mode and combines the first group of sensing data values, the second group of sensing data values, the third group of sensing data values and the fourth group of sensing data values, which are acquired last in the idle mode, into a group of initial data values in the operating mode.

In one embodiment of the present invention, when the touch panel device is in the operating mode, the touch panel device scans the first sensing lines, the second sensing lines, the third sensing lines and the fourth sensing lines during each of the first frame periods and each of the second frame periods.

In conclusion, the present invention achieves the object of reducing power consumption without decreasing the predetermined frame rate by respectively scanning the odd number of sensing lines and the even number of sensing lines which are alternately arranged. The first combined image after the touch event occurs may be generated by the previously detected sensing data values. The present invention may utilize the original resource without additional computations, and thus the reduction of power consumption may be achieved.

### BRIEF DESCRIPTION OF THE DRAWINGS

The present invention can be more fully understood by reading the following detailed description of the embodiments, with reference made to the accompanying drawings as follows:

FIG. 1 is a diagram of a touch panel device according to an embodiment of the present invention;

FIG. 2A is a diagram showing a scanning process of the touch panel device in an idle mode during first frame periods according to an embodiment of the present invention;

FIG. 2B is a diagram showing a scanning process of the touch panel device in the idle mode during second frame periods according to an embodiment of the present invention; and

FIG. 3 is a flow chart showing a scanning method of the touch panel device shown in FIG. 1 according to an embodiment of the present invention.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a,” “an,” and “the” includes reference to the plural unless the context clearly dictates otherwise. Also, as used in the description herein and throughout the claims that follow, the terms “comprise or comprising,” “include or including,” “have or having,” “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

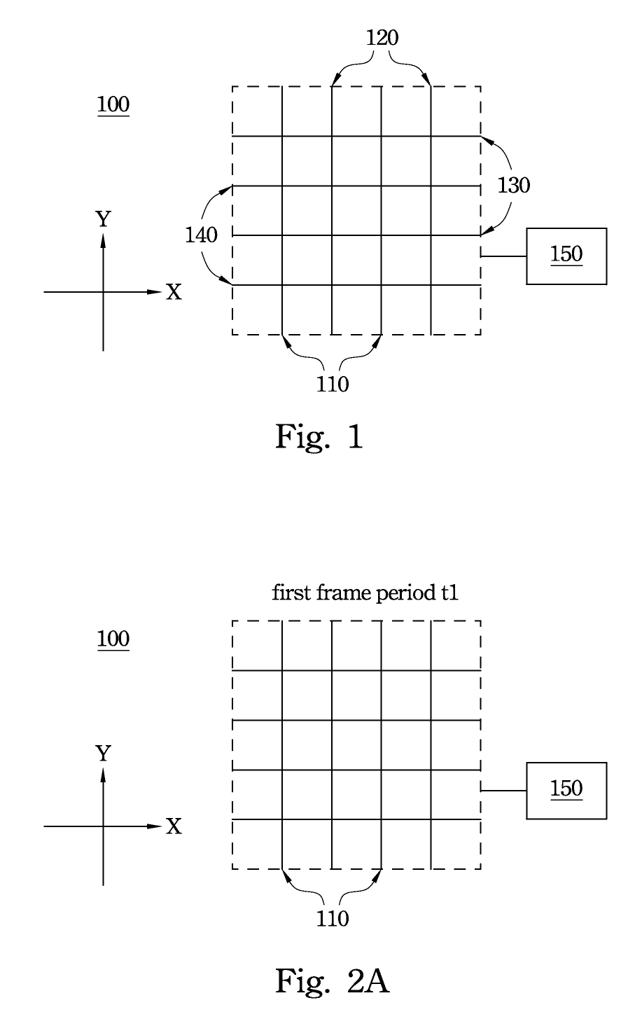

FIG. 1 is a diagram of a touch panel device 100 according to an embodiment of the present invention. The touch panel device 100 includes first sensing lines 110, second sensing lines 120 and a controlling module 150. The first sensing lines 110 and the second sensing lines 120 are alternately arranged and are in parallel with each other along a first direction. For example, for a plurality of sensing lines which are in parallel with each other, the first one of the sensing lines is a first sensing line 110; the next one of the sensing lines is the second sensing line 120; the further next one of the sensing lines is the first sensing line 110 again, and the rest of the sensing lines are repeated in a similar manner. That is, the first sensing lines 110 are the odd number of sensing lines and the second sensing lines 120 are the even number of sensing lines. Surely, the first sensing lines 110 also can be referred to as the even number of sensing lines and the second sensing lines 120 also can be referred to as the odd number of sensing lines, as known to those skilled in the art, and the embodiments of the present invention are affected thereby.

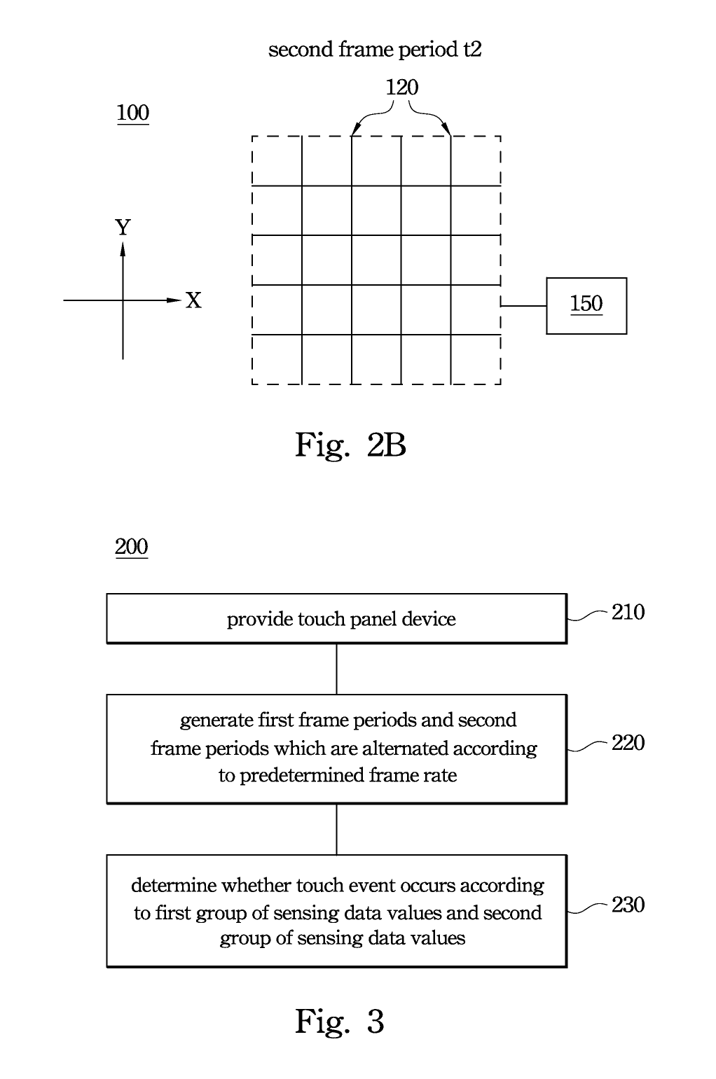

FIG. 2A is a diagram showing a scanning process of the touch panel device 100 in an idle mode during first frame periods t1 according to an embodiment of the present invention. FIG. 2B is a diagram of a scanning process of the touch panel device 100 in the idle mode during second frame periods t2 according to an embodiment of the present invention. Referring to FIG. 1, FIG. 2A and FIG. 2B, the controlling module 150 is configured to scan the first sensing lines 110 and the second sensing lines 120 during the first frame periods t1 and the second frame periods t2, respectively, which are alternately generated according to a predetermined frame rate. For example, the first sensing lines 110 are scanned during the first frame periods t1, and the second sensing lines 120 are scanned during the second frame periods t2. In practice, the controlling module 150 may be an integrated circuit module. Furthermore, one first frame period t1 occurs before one second frame period t2, and then another first frame period t1 occurs, and thereafter another second frame period t2 occurs; that is, the first frame periods t1 and the second frame periods t2 are alternately and sequentially generated.

The controlling module 150 is equipped with the idle mode and an operating mode. For saving power consumption, when the controlling module 150 is in the idle mode, the controlling module 150 only scans the first sensing lines 110 during each of the first frame periods t1 to acquire a first group of sensing data values, and only scans the second sensing lines 120 during each of the second frame periods t2 to acquire a second group of sensing data values. The controlling module 150 determines whether a touch event occurs according to the first group of sensing data values and the second group of sensing data values. The touch event may occur, for example, when a user desires to use the touch panel device 100 and the user touches a touch panel. By changing the manner of scanning the sensing lines in the idle mode, in which the sensing lines are divided into two groups (an odd-numbered group and an even-numbered group) and only one group is scanned during specific frame periods, and thus the object of saving power can be achieved by reducing the number of the scanned sensing lines in one frame period.

In one embodiment, when the controlling module 150 is in the operating mode, the reaction requirement for touching and sensing in the operating mode is different from that in the idle mode, and thus the controlling module 150 scans the first sensing lines 110 and the second sensing lines 120 during each of the first frame periods t1 and each of the second frame periods t2, i.e., the controlling module 150 scans both the first sensing lines 110 and the second sensing lines 120 during any one of the frame periods, which is different from an interlaced scanning manner in the idle mode, and therefore the required sensitivity of the touch panel can be obtained in the operating mode.

As shown in FIG. 1, in one embodiment, the touch panel device 100 includes the first sensing lines 110, the second sensing lines 120, third sensing lines 130, fourth sensing lines 140 and the controlling module 150. The first sensing lines 110 and the second sensing lines 120 are alternately arranged and are in parallel with each other along the first direction, and the third sensing lines 130 and the fourth sensing lines 140 are alternately arranged and are in parallel with each other along a second direction which is perpendicular to the first direction. The arrangement of the third sensing lines 130 and the fourth sensing lines 140 is similar to that of the first sensing lines 110 and the second sensing lines 120, e.g., for a plurality of sensing lines which are in parallel with each other, the first one of the sensing lines is the third sensing line 130, the second one of the sensing lines is the fourth sensing line 140, the third one of the sensing lines is the third sensing line 130, and the fourth one of the sensing lines is the fourth sensing line 140, and the rest of the sensing lines are repeated in a similar manner. In the present embodiment, the second direction is perpendicular to the first direction, e.g., the first direction is a X-axial direction and the second direction is a Y-axial direction, or the first direction is an east-west direction and the second direction is a south-north direction. It is noted that, although the arrangement of the first sensing lines 110, the second sensing lines 120, the third sensing lines 130 and the fourth sensing lines 140 is shown in FIG. 1, yet the present invention is not limited thereto, and the arrangement may be adjusted by those skilled in the art according to practical situations.

When the controlling module 150 is in the idle mode, the controlling module 150 only scans the third sensing lines 130 during each of the first frame periods t1 to acquire a third group of sensing data values, and only scans the fourth sensing lines 120 during each of the second frame periods t2 to acquire a fourth group of sensing data values. The controlling module 150 determines whether the touch event occurs according to the first group of sensing data values, the second group of sensing data values, the third group of sensing data values and the fourth group of sensing data values. Hence, the power saving result can be achieved by dividing the sensing lines into groups and controlling the number of the scanned sensing lines in the idle mode. It is noted that the order of scanning the first sensing lines 110, the second sensing lines 120, the third sensing lines 130 and the fourth sensing lines 140 is not limited thereto, and may be modified adaptively by those skilled in the art according to practical situations.

In one embodiment, when the touch event occurs, the controlling module 150 is switched to be in the operating mode and combines the first group of sensing data values, the second group of sensing data values, the third group of sensing data values and the fourth group of sensing data values, which are acquired last in the idle mode, into a group of initial data values in the operating mode. For example, when the touch event occurs, the controlling module 150 has recorded several groups of sensing data values, and the group of initial data values is generated according to the first group of sensing data values, the second group of sensing data values, the third group of sensing data values and the fourth group of sensing data values, which are acquired immediately prior to the touch event occurs.

When the controlling module 150 is switched from the idle mode to the operating mode, an algorithm of the touch panel device 100 in the operating mode needs the information of all the sensing lines for calculation. The predetermined frame rate is not set to be a low value in the idle mode, such that the information of the sensing lines stored originally in the idle mode can be adopted in the operating mode, thereby simplifying the complicated process of the algorithm.

In one embodiment, when the controlling module 150 is in the operating mode, the reaction sensitivity of the touch panel should be detected in the operating mode. Different from the interlaced scanning manner in the idle mode, the controlling module 150 scans the first sensing lines 110, the second sensing lines 120, the third sensing lines 130 and the fourth sensing lines 140 during each of the first frame periods t1 and each of the second frame periods t2. For example, the controlling module 150 alternately scans the first sensing lines 110 and the second sensing lines 120 during the first frame periods t1, i.e., the controlling module 150 performs the scanning process along the +X-axial direction, in which one of the first sensing lines 110 is first scanned and then one of the second sensing lines 120 is scanned, and then the next one of the first sensing lines 110 is scanned, and the rest of the sensing lines are repeated in a similar manner. The controlling module 150 alternately scans the third sensing lines 130 and the fourth sensing lines 140 during the second frame periods t2. The scanning process for the third sensing lines 130 and the fourth sensing lines 140 is similar to that for the first sensing lines 110 and the second sensing lines 120. The controlling module 150 performs the scanning process along the −Y-axial direction, in which one of the third sensing lines 130 is first scanned and then one of the fourth sensing lines 140 is scanned, and then the next one of the third sensing lines 130 is scanned, and the rest of the sensing lines are repeated in a similar manner. The order of scanning is not limited by the foregoing descriptions, and may be adaptively modified by those skilled in the art according to practical situations.

FIG. 3 is a flow chart showing a scanning method 200 in the touch panel device 100 according to an embodiment of the present invention. The hardware for performing the scanning method 200 has been disclosed in the foregoing embodiment and thus is not further described in detail. Except for steps described as being in a specific order, the order of the steps of the scanning method 200 in the present embodiment is not limited.

The scanning method 200 in the touch panel device 100 includes steps 210-220. In step 210, the touch panel device 100 is provided, in which the touch panel device 100 is equipped with the idle mode and the operating mode, and has the first sensing lines 110 and the second sensing lines 120 which are alternately arranged and are in parallel with each other along the first direction. For example, for a plurality of sensing lines which are in parallel with each other, the first one of the sensing lines is the first sensing line 110, the next one of the sensing lines is the second sensing line 120, the further next one of the sensing lines is the first sensing line 110, and the rest of the sensing lines are repeated in a similar manner. For controlling the operation of the touch panel device 100 in the idle mode and the operating mode, in step 220, the first frame periods t1 and the second frame periods t2 are generated alternately according to the predetermined frame rate.

Next, in step 230, when the touch panel device 100 is in the idle mode, the touch panel device 100 only scans the first sensing lines 110 during each of the first frame periods t1 to acquire the first group of sensing data values, and only scans the second sensing lines 120 during each of the second frame periods t2 to acquire the second group of sensing data values, and determines whether the touch event occurs according to the first group of sensing data values and the second group of sensing data values. By using the interlaced scanning manner performed for the sensing lines, the scanning process can be performed without changing the predetermined frame rate and the determination of whether the touch event occurs is not affected. Thus, the object of saving power and the reaction requirement for touching operation can be achieved.

In one embodiment, the scanning method 200 further includes the steps described below. When the touch panel device 100 is in the operating mode, the touch panel device 100 scans the first sensing lines 110 and the second sensing lines 120 during each of the first frame periods t1 and each of the second frame periods t2. The scanning manners in the idle mode and the operating mode are different from each other. The power saving result may be achieved by performing the interlaced scanning manner in the idle mode, and the operation requirement may be achieved by scanning every one of the sensing lines in the operating mode.

In one embodiment, the touch panel device 100 has the third sensing lines 130 and the fourth sensing lines 140 which are alternately arranged and are in parallel with each other along the second direction which is perpendicular to the first direction. The scanning method 200 in the touch panel device 100 may further include the steps described below. When the touch panel device 100 is in the idle mode, the touch panel device 100 only scans the third sensing lines 130 during each of the first frame periods t1 to acquire the third group of sensing data values, and only scans the fourth sensing lines 140 during each of the second frame periods t2 to acquire the fourth group of sensing data values, and determines whether the touch event occurs according to the first group of sensing data values, the second group of sensing data values, the third group of sensing data values and the fourth group of sensing data values. Similar to step 220, reduction in power consumption can be achieved by the interlaced scanning manner performed for the sensing lines in the idle mode.

In another embodiment, when the touch event occurs, the touch panel device 100 is switched to be in the operating mode and combines the first group of sensing data values, the second group of sensing data values, the third group of sensing data values and the fourth group of sensing data values, which are acquired last in the idle mode, into the group of initial data values in the operating mode. By directly using the previous data values without acquiring additional data values, the efficiency of switching the mode of operation from the idle mode to the operating mode can be increased.

In still another embodiment, the scanning method 200 further includes the steps described below. When the touch panel device 100 is in the operating mode, the touch panel device 100 scans the first sensing lines 110, the second sensing lines 120, the third sensing lines 130 and the fourth sensing lines 140 during each of the first frame periods t1 and each of the second frame periods t2. Similar to the foregoing descriptions, the scanning manners in the operating mode and the idle mode in which the interlaced scanning manner is performed are different. By scanning each of the sensing lines, the detection of reaction for touching operation in the operating mode can be more efficient.

In conclusion, the scanning manner is changed to the interlaced scanning manner in the idle mode. By performing the interlaced scanning manner, the predetermined frame rate may not be decreased too much, and the object of saving power still can be achieved. Additionally, if it is required that the predetermined frame rate cannot be too low, this scanning manner may save more power without decreasing the predetermined frame rate.

In one embodiment, the touch panel device 100 has 16 sensing lines, and the predetermined frame rate is 10 Hz. In a full scanning manner, 16×10=160 sensing lines are scanned in one second. In the interlaced scanning manner, only 8×10=80 sensing lines are scanned in one second. Thus, the predetermined frame rate may be increased to 20 Hz to keep the number of scanned lines being 20×8=160.

Additionally, this method has another advantage. The algorithm in operating mode needs the information of all sensing lines for calculation. Since the predetermined frame rate is not decreased to a low value, when the operation mode is switched from the idle mode to the operating mode, the first group of sensing data value, the second group of sensing data values, the third group of sensing data values and the fourth group of sensing data values, which are acquired at the last in the idle mode, may be combined into a first group of data values in the operating mode. This method uses of previous data values without acquiring additional data values of the sensing lines. Thus, the efficiency of switching form the idle mode to the operating mode can be increased.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A touch panel device, comprising:
a plurality of first sensing lines and a plurality of second sensing lines, wherein the first sensing lines and the second sensing lines are alternately arranged and are in parallel with each other along a first direction; and
a controlling module configured to scan the first sensing lines and the second sensing lines during a plurality of first frame periods and a plurality of second frame periods, respectively, wherein the first frame periods and the second frame periods are alternately generated according to a predetermined frame rate; the controlling module is equipped with an idle mode and an operating mode; and, when the controlling module is in the idle mode, the controlling module only scans the first sensing lines during each of the first frame periods to acquire a first group of sensing data values, and the controlling module only scans the second sensing lines during each of the second frame periods to acquire a second group of sensing data values, and the controlling module determines whether a touch event occurs according to the first group of sensing data values and the second group of sensing data values.

2. The touch panel device of claim 1, wherein when the controlling module is in the operating mode, the controlling module scans the first sensing lines and the second sensing lines during each of the first frame periods and each of the second frame periods.

3. The touch panel device of claim 1, further comprising:
a plurality of third sensing lines and a plurality of fourth sensing lines, wherein the third sensing lines and the fourth sensing lines are alternately arranged and are in parallel with each other along a second direction which is perpendicular to the first direction;
wherein when the controlling module is in the idle mode, the controlling module only scans the third sensing lines during each of the first frame periods to acquire a third group of sensing data values, and the controlling module only scans the fourth sensing lines during each of the second frame periods to acquire a fourth group of sensing data values, and the controlling module determines whether the touch event occurs according to the first group of sensing data values, the second group of sensing data values, the third group of sensing data values and the fourth group of sensing data values.

4. The touch panel device of claim 3, wherein when the touch event occurs, the controlling module is switched to be in the operating mode and combines the first group of sensing data values, the second group of sensing data values, the third group of sensing data values and the fourth group of sensing data values, which are acquired last in the idle mode, into a group of initial data values in the operating mode.

5. The touch panel device of claim 3, wherein when the controlling module is in the operating mode, the controlling module scans the first sensing lines, the second sensing lines, the third sensing lines and the fourth sensing lines during each of the first frame periods and each of the second frame periods.

6. A scanning method in a touch panel device, the scanning method comprising:
providing a touch panel device, wherein the touch panel device is equipped with an idle mode and an operating mode, and has a plurality of first sensing lines and a plurality of second sensing lines which are alternately arranged and are in parallel with each other along a first direction;
generating a plurality of first frame periods and a plurality of second frame periods which are alternately generated according to a predetermined frame rate; and
when the touch panel device is in the idle mode, the touch panel device only scans the first sensing lines during each of the first frame periods to acquire a first group of sensing data values, and only scans the second sensing lines during each of the second frame periods to acquire a second group of sensing data values, and determines whether a touch event occurs according to the first group of sensing data values and the second group of sensing data values.

7. The scanning method of claim 6, further comprising:
when the touch panel device is in the operating mode, the touch panel device scans the first sensing lines and the second sensing lines during each of the first frame periods and each of the second frame periods.

8. The scanning method of claim 6, wherein the touch panel device has a plurality of third sensing lines and a plurality of fourth sensing lines which are alternately arranged and are in parallel with each other along a second direction which is perpendicular to the first direction, and the scanning method further comprises:
when the touch panel device is in the idle mode, the touch panel device only scans the third sensing lines during each of the first frame periods to acquire a third group of sensing data values, and only scans the fourth sensing lines during each of the second frame periods to acquire a fourth group of sensing data values, and determines whether the touch event occurs according to the first group of sensing data values, the second group of sensing data values, the third group of sensing data values and the fourth group of sensing data values.

9. The scanning method of claim 8, wherein when the touch event occurs, the touch panel device is switched to be in the operating mode and combines the first group of sensing data values, the second group of sensing data values, the third group of sensing data values and the fourth group of sensing data values, which are acquired last in the idle mode, into a group of initial data values in the operating mode.

10. The scanning method of claim 8, wherein when the touch panel device is in the operating mode, the touch panel device scans the first sensing lines, the second sensing lines, the third sensing lines and the fourth sensing lines during each of the first frame periods and each of the second frame periods.
